(19) United States
(12) Patent Application Publication
(10) Pub. No.: US 2023/0237337 A1
(43) Pub. Date: Jul. 27, 2023

(54) LARGE MODEL EMULATION BY KNOWLEDGE DISTILLATION BASED NAS

(71) Applicant: HUAWEI TECHNOLOGIES CO., LTD., Shenzhen (CN)

(72) Inventors: Fabio Maria CARLUCCI, Munich (DE); Philip TORR, Oxford (GB); Roy EYONO, Quebec (CA); Pedro M. ESPERANCA, Munich (DE); Binxin RU, Munich (DE)

(21) Appl. No.: 18/193,815

(22) Filed: Mar. 31, 2023

Related U.S. Application Data
(63) Continuation of application No. PCT/EP2020/077546, filed on Oct. 1, 2020.

(51) Int. Cl. G06N 3/082

(52) U.S. Cl. CPC G06N 3/082

(57) ABSTRACT

Described herein is a machine learning mechanism implemented by one or more computers, the mechanism having access to a base neural network and being configured to determine a simplified neural network by iteratively performing the following set of steps: forming sample data by sampling the architecture of a current candidate neural network; selecting, in dependence on the sample data, an architecture for a second candidate neural network; forming a trained candidate neural network by training the second candidate neural network, wherein the training of the second candidate neural network comprises applying feedback to the second candidate neural network in dependence on a comparison of the behaviours of the second candidate neural network and the base neural network; and adopting the trained candidate neural network as the current candidate neural network for a subsequent iteration of the set of steps.

### CROSS-REFERENCE TO RELATED APPLICATIONS

This disclosure is a continuation of International Application No. PCT/EP2020/077546, filed on Oct. 1, 2020, the disclosure of which is hereby incorporated by reference in its entirety.

### FIELD OF THE INVENTION

This invention relates to the emulation of large, high-capacity models in machine learning by smaller, more efficient models.

### BACKGROUND

In machine learning, large models such as deep neural networks may have a high knowledge capacity which is not always fully utilized. It can be computationally expensive to evaluate such models. Furthermore, State Of The Art machine learning models developed and trained on computers cannot always be deployed on smaller, less computationally complex devices. This could be due to the models being too big to be stored in the memory of the device, or simply requiring operations which are not supported by the device's hardware.

Knowledge Distillation (KD) can be used to transfer the knowledge from a State of The Art teacher model to a smaller student model. The main limitation of this approach is that the student model needs to be carefully designed by hand, which is generally extremely difficult and time consuming.

Pruning, Quantization and Factorization are methods which may be used to simplify a high-capacity State of the Art model. However, these methods cannot change the specific operations being used and thus are of no help when unsupported operations are being used.

Methods such as that disclosed in Liu, Yu, et al. “Search to Distill: Pearls are Everywhere but not the Eyes”, Proceedings of the IEEE/CVF Conference on Computer Vision and Pattern Recognition, 2020, automatically search for the student model. However, the efficiency may be poor and such methods are not able to perform true multi-objective optimization.

It is desirable to develop a method for emulating large models that overcomes such problems.

### SUMMARY

According to one aspect there is provided a machine learning mechanism implemented by one or more computers, the mechanism having access to a base neural network and being configured to determine a simplified neural network by iteratively performing the following set of steps: forming sample data by sampling the architecture of a current candidate neural network; selecting, in dependence on the sample data, an architecture for a second candidate neural network; forming a trained candidate neural network by training the second candidate neural network, wherein the training of the second candidate neural network comprises applying feedback to the second candidate neural network in dependence on a comparison of the behaviours of the second candidate neural network and the base neural network; and adopting the trained candidate neural network as the current candidate neural network for a subsequent iteration of the set of steps. This may allow a candidate neural network to be trained that can emulate a larger base network. The mechanism may allow for superior performance on desired tasks and has the flexibility to automatically adapt to different requirements. There is no need for a human expert.

The machine learning mechanism may comprise, after multiple iterations of the said set of steps, outputting the current candidate neural network as the simplified neural network. This may allow a simplified neural network to be determined that demonstrates good performance.

The simplified neural network may have a smaller capacity and/or is less computationally intensive to implement than the base neural network. This may allow the simplified network to be run on devices having less computational power than the computer that trained the models.

The step of selecting an architecture for the second candidate neural network may be performed by Bayesian optimisation. As a Bayesian optimization framework is very data efficient, and is particularly useful in situations where evaluations are costly, where one does not have access to derivatives, and where the function of interest is non-convex and multimodal. In these situations, Bayesian optimization is able to take advantage of the full information provided by the history of the optimization to make the search efficient.

The step of selecting an architecture for the second candidate neural network may be performed by multi-objective Bayesian optimisation. This may allow an architecture to be found that not only performs best accuracy wise, but also according to a secondary (or further) objective.

The step of selecting an architecture for the second candidate neural network may be performed by Bayesian optimisation having one or more objectives, wherein at least one of said objectives refers to one or mor of (i) improved classification accuracy of the second candidate neural network and (ii) reduced computational intensiveness of the second candidate neural network. This may allow a network architecture to be determined for the simplified neural network that has improved accuracy and/or has a lower computational intensiveness than the base network.

The sample data may be formed by sampling the current candidate neural network according to a predetermined acquisition function. This may be an efficient method of forming the sample data.

The step of selecting an architecture for a second candidate neural network may be performed by optimisation over a stochastic graph of network architectures. Optimising the stochastic distribution of architectures, rather than a deterministic architectures itself, may deliver results having good accuracy, at a fraction of the cost. This may allow the optimal network architecture for the student model to be determined.

The step of forming the trained candidate neural network may comprise causing the second candidate neural network to perform a plurality of tasks, causing the base neural network to perform the plurality of tasks, and modifying the second candidate neural network in dependence on a variance between the performances of the second candidate neural network and the base neural network in performing the tasks. This may allow an accurate student model to be determined.

The mechanism may have access to a trained neural network and may be configured to determine the base neural network by iteratively performing the following set of steps: forming sample data by sampling the architecture of a current candidate base neural network; selecting, in dependence on the sample data, an architecture for a second candidate base neural network; forming a trained candidate base neural network by training the second candidate base neural network, wherein the training of the second candidate base neural network comprises applying feedback to the second candidate base neural network in dependence on a comparison of the behaviours of the second candidate base neural network and the trained neural network; and adopting the trained candidate base neural network as the current candidate base neural network for a subsequent iteration of the set of steps; and after multiple iterations of those steps, adopting the current candidate base neural network as the base neural network. This may allow for the determination of a teaching assistant network as the base network from the teacher network (the trained neural network).

The base neural network may have a smaller capacity and/or be less computationally intensive to implement and/or less complex than the trained neural network. It may be more efficient to use a smaller teaching assistant from which to determine the student model if there is a large capacity gap between the teacher and the student models.

The base neural network may be a teaching assistant network for facilitating the formation of the simplified neural network. The use of a teaching assistant network may be particularly advantageous where there is a large difference in capacity between the teacher and the student networks.

The mechanism may be configured to install the simplified neural network for execution on a device having lower computational complexity than the said one or more computers. This may allow the simplified model to be efficiently executed on smaller, less computationally complex devices, such as tablets or mobile phones.

The step of selecting an architecture for a second candidate neural network may be performed by optimisation over a stochastic graph of network architectures, the stochastic graph having been predetermined in dependence on one or more capabilities of the said device. Optimising the stochastic distribution of architectures, rather than a deterministic architecture itself, may deliver results with good accuracy, at a fraction of the cost.

According to a further aspect there is provided a computer-implemented method for determining a simplified neural network in dependence on a base neural network, the method comprising iteratively performing the following set of steps: forming sample data by sampling the architecture of a current candidate neural network; selecting, in dependence on the sample data, an architecture for a second candidate neural network; forming a trained candidate neural network by training the second candidate neural network, wherein the training of the second candidate neural network comprises applying feedback to the second candidate neural network in dependence on a comparison of the behaviours of the second candidate neural network and the base neural network; and adopting the trained candidate neural network as the current candidate neural network for a subsequent iteration of the set of steps. This may allow a candidate neural network to be trained that can emulate a larger base network. The method may allow for superior performance on desired tasks and has the flexibility to automatically adapt to different requirements. There is no need for a human expert.

### BRIEF DESCRIPTION OF THE FIGURES

The present invention will now be described by way of example with reference to the accompanying drawings.

In the drawings:

FIG. 1 shows an implementation of a machine learning mechanism whereby the best student model can be determined.

FIG. 2 shows the steps of a machine learning mechanism for determining a simplified neural network in dependence on a base neural network.

FIG. 3 shows an implementation utilizing a teaching assistant network.

FIG. 4 shows the steps of a machine learning mechanism according to an embodiment of the invention utilising a teaching assistant network.

FIG. 5 shows an example of a system comprising a computer for determining the simplified neural network and a device for implementing the simplified neural network.

### DETAILED DESCRIPTION

In the machine learning mechanism described herein, the architecture of a student model is automatically learned, as well as the optimal relevant KD hyper-parameters, in order to maximally exploit KD, without the need for a human expert. In the examples described herein, the models are neural networks and the method combines Knowledge Distillation with Neural Architecture Search (NAS). The architecture and the relevant hyper-parameters (for example, KD temperature and loss weight) of the smaller, student model are searched for. Where there is a large gap in capacity between the teacher and student models, the approach also extends to searching for the architecture and the hyper-parameters of a teaching assistant model.

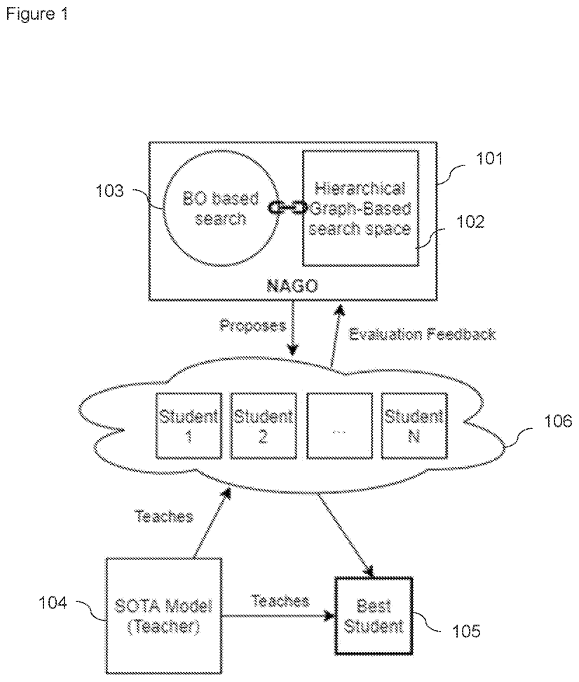

FIG. 1 shows the different elements being considered. In a preferred implementation, the method optimizes over a stochastic graph generator, such as NAGO, as the search space. NAGO (Neural Architecture Generator Optimization) is the NAS module 101. It defines a search space for networks, shown at 102, including architectural and training parameters, and a strategy for optimizing them based on multi-objective Bayesian optimization, shown at 103. This means that NAGO may allow the mechanism to find the architecture that not only performs best accuracy wise, but also according to a secondary objective (floating-point operations (FLOPS), for example).

The teacher model 104 is the state-of-the-art model that it is desirable to emulate in a smaller student model. The teacher's capacity (in terms of parameters) can vary, while the student's capacity is preferably fixed to a given value based on the requirements (for example, the requirements or capabilities of a device on which the student model is to be run).

During the search phase, the NAS module 101 proposes architectures and hyper-parameters (illustrated as students 1 through N at 106), which are trained through KD to absorb the teacher's knowledge. The architecture for the student is therefore optimised over a stochastic graph of network architectures. Optimising the stochastic distribution of architectures, rather than a deterministic architecture itself, may deliver the same accuracy results, at a fraction of the cost (see, for example, Ru, Binxin, Pedro Esperanca, and Fabio Carlucci, “Neural Architecture Generator Optimization”, arXiv preprint arXiv:2004.01395 (2020) and Xie, Saining, et al. “Exploring randomly wired neural networks for image recognition”, Proceedings of the IEEE International Conference on Computer Vision, 2019). Once the search phase ends, the system returns the optimal student 105.

More generally, sample data is formed by sampling the architecture of a current candidate student neural network. The sample data may be formed by sampling the current candidate student neural network according to a predetermined acquisition function. In dependence on the sample data, an architecture for a second student candidate neural network is determined.

Generally, the step of forming the trained student neural network comprises causing the candidate student neural network to perform a plurality of tasks and causing the teacher neural network to perform the plurality of tasks. The candidate student neural network is the modified in dependence on a variance between the performances of the candidate student neural network and the teacher neural network in performing the tasks.

More formally:

Given: a teacher T, a Bayesian Optimization surrogate model S, an acquisition function A, a desired task Q.

Loop:
1. Sample student architecture & KD parameters (temperature and loss weight) according to A
2. Train student, with KD from T, on Q and obtain a task metric
3. Update S and A
4. Repeat until there is budget available

Return optimal student architecture and corresponding KD parameters.

The student model can then be installed for execution on a device having lower computational complexity than the one or more computers that trained the student. The stochastic graph of network architectures that is optimised over may have been predetermined in dependence on one or more capabilities of the said device.

As illustrated above, the method described herein uses Bayesian optimization to select an architecture for the student. As the Bayesian optimization framework is very data efficient, it is particularly useful in situations where evaluations are costly, where one does not have access to derivatives, and where the function of interest is non-convex and multimodal. In these situations, Bayesian optimization is able to take advantage of the full information provided by the history of the optimization to make this search efficient (see, for example, Shahriari, Bobak, et al. “Taking the human out of the loop: A review of Bayesian optimization”, Proceedings of the IEEE 104.1 (2015): 148-175). In some implementations, multi-objective Bayesian optimisation may be used. The Bayesian optimisation may have one or more objectives, wherein at least one of said objectives refers to (i) improved classification accuracy of the second candidate neural network and/or (ii) reduced computational intensiveness of the second candidate neural network. This may assist in forming a student neural network that is accurate and less computationally intensive that the teacher nural network.

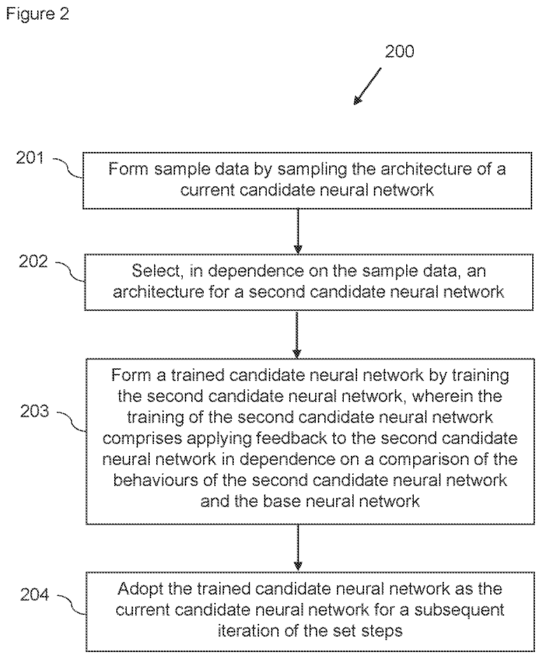

FIG. 2 summarises the steps of a machine learning mechanism 200 implemented by one or more computers, the mechanism having access to a base neural network (such as the teacher model 104 described herein) and being configured to determine a simplified neural network (such as the student model 105 described herein) by iteratively performing the following set of steps. At step 201, the mechanism forms sample data by sampling the architecture of a current candidate neural network. At step 202, the mechanism selects, in dependence on the sample data, an architecture for a second candidate neural network. At step 203, the mechanism forms a trained candidate neural network by training the second candidate neural network, wherein the training of the second candidate neural network comprises applying feedback to the second candidate neural network in dependence on a comparison of the behaviours of the second candidate neural network and the base neural network. At step 204, the mechanism adopts the trained candidate neural network as the current candidate neural network for a subsequent iteration of the set of steps. After multiple iterations of this set of steps, the current candidate neural network is output at the as the simplified neural network.

The simplified student neural network has a smaller capacity and/or is less computationally intensive to implement than the teacher neural network. This may allow the student network to be run on devices having less computational power than the computer that trained the model(s).

When the teacher's capacity (as expressed by the number of parameters) is much greater than that of the student, it may be advantageous to introduce a teaching assistant (TA), as described in Mirzadeh, Seyed-Iman, et al. “Improved Knowledge Distillation via Teacher Assistant.” arXiv preprint arXiv:1902.03393 (2019). The teaching assistant can be used to ease the transfer between the teacher network, which has a relatively high capacity, and the student network, which may have a much lower capacity than the teacher network.

The teaching assistant may be hand designed, both in term of architecture and capacity, requiring (as in traditional KD) the need for a human expert. Alternatively, the teaching assistant may be itself determined by KD/NAS as described above for the student.

In one implementation, instead of automatically searching for the optimal teaching assistant architecture and capacity during the search for the student, the teaching assistant preferably shares the same architecture as the student and the capacity is included in the search space and thus optimized.

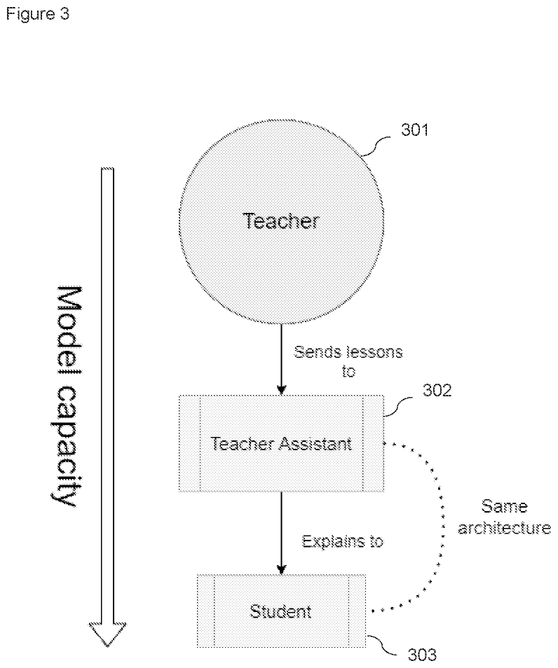

As shown in FIG. 3, when a new proposal needs to be evaluated, the student 303 and the teaching assistant 302 can be initialized with the same proposed architecture but with different capacities: the student 303 with the desired capacity and the teaching assistant 302 with the (searched) capacity that allows for maximum knowledge transfer from the teacher 301.

The previous algorithm can thus be extended, as illustrated below:

Given: a teacher T, a Bayesian Optimization surrogate model S, an acquisition function A, a desired task Q.

Loop:
1. Sample the architecture & KD parameters (temperature and loss weight) and the TA capacity according to A
2. Use the architecture to initialize both the student (with fixed capacity) and the TA (proposed value)
3. At the same time, perform KD between T and TA, and between TA and student. Obtain a task metric
4. Update S and A
5. Repeat until there is budget available

Return optimal architecture and corresponding KD parameters.

The approach may also be extended for multi-objective optimization.

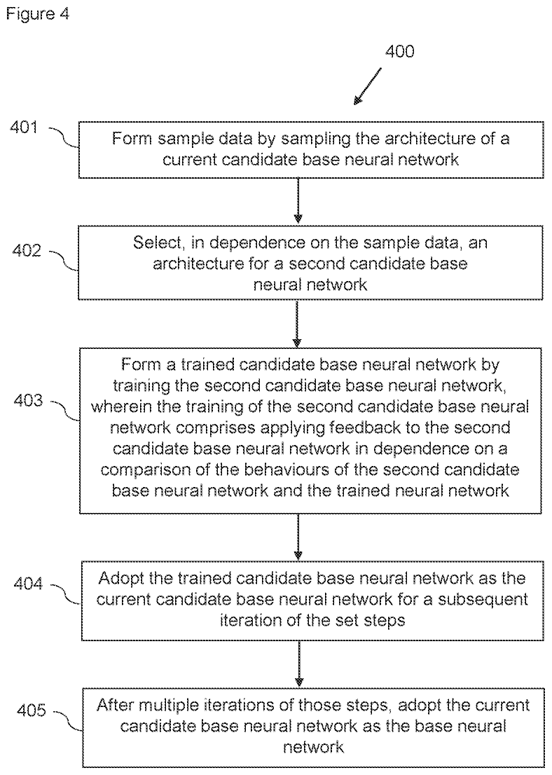

FIG. 4 shows machine learning mechanism that can be used to determine the teaching assistant, which can then act as the base neural network for the student. The mechanism has access to a trained neural network (such as teacher 301) and is configured to determine the base neural network (such as TA network 302) by iteratively performing the following set of steps. At step 401, the mechanism forms sample data by sampling the architecture of a current candidate base neural network. At step 402, the mechanism selects, in dependence on the sample data, an architecture for a second candidate base neural network. At step 403, the mechanism forms a trained candidate base neural network by training the second candidate base neural network, wherein the training of the second candidate neural network comprises applying feedback to the second candidate base neural network in dependence on a comparison of the behaviours of the second candidate base neural network and the trained neural network. At step 404, the mechanism adopts the trained candidate base neural network as the current candidate base neural network for a subsequent iteration of the set of steps. At step 405, after multiple iterations of those steps, the mechanism adopts the current candidate base neural network as the base neural network. This base neural network, which has a smaller capacity than the original trained teacher neural network, can then be used to determine the student neural network, as described above.

For simplicity, the exemplary algorithms shown herein are presented for the case of a single objective. However, the method can be extended to multiple objectives. For example, by simply by using NAGO's multi-objective implementation. Doing so enables the determination of models which are not only optimal in terms of a single task metric (e.g. accuracy), but also in terms of any other secondary metrics (e.g. memory footprint, FLOPS) that might be of interest.

The approach may also deal with unsupported operations. Preferably, the search space contains simple operations which are available on a large range of hardware devices. For example, by default, NAGO's search space contains simple operations which are likely to be available on a very large range of device hardwares. In the event that a specific device has particular hardware requirements, the search space may be easily modified to omit the offending operation and the rest of the algorithm may be run as previously described.

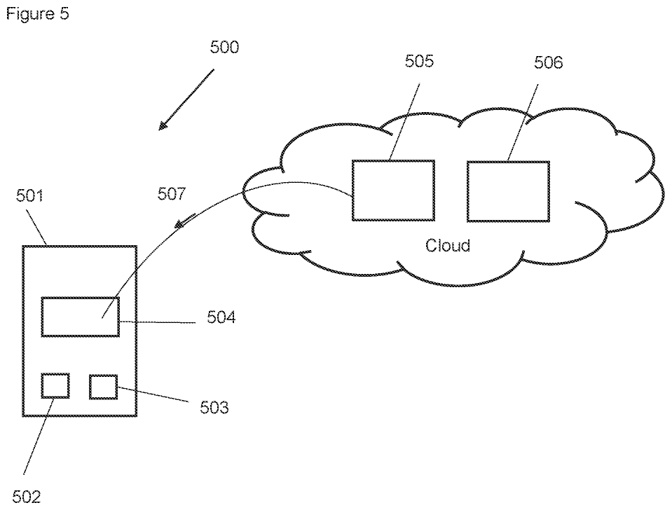

FIG. 5 shows an example of a system 500 comprising a device 501. The device 501 comprises a processor 502 and a memory 503. The processor may execute the student model. The student model may be stored at memory 503. The processor 502 could also be used for the essential functions of the device.

The transceiver 504 is capable of communicating over a network with other entities 505, 506. Those entities may be physically remote from the device 501. The network may be a publicly accessible network such as the internet. The entities 505, 506 may be based in the cloud. Entity 505 is a computing entity. Entity 506 is a command and control entity. These entities are logical entities. In practice they may each be provided by one or more physical devices such as servers and data stores, and the functions of two or more of the entities may be provided by a single physical device. Each physical device implementing an entity comprises a processor and a memory. The devices may also comprise a transceiver for transmitting and receiving data to and from the transceiver 504 of device 501. The memory stores in a non-transient way code that is executable by the processor to implement the respective entity in the manner described herein.

The command and control entity 506 may train the models used in the device. This is typically a computationally intensive task, even though the resulting student model may be efficiently described, so it may be efficient for the development of the algorithm to be performed in the cloud, where it can be anticipated that significant energy and computing resource is available.

In one implementation, once the algorithms have been developed in the cloud, the command and control entity can automatically form a corresponding model and cause it to be transmitted from the computer 505 to the relevant device 501. In this example, the optimal student model is implemented at the device 501 by processor 502.

Therefore, the machine learning mechanism described herein may be deployed in multiple ways, for example in the cloud, or alternatively in dedicated hardware. As indicated above, the cloud facility could perform training to develop new algorithms or refine existing ones. Depending on the compute capability near to the data corpus, the training could either be undertaken close to the source data, or could be undertaken in the cloud, e.g. using an inference engine. The method may also be implemented in a dedicated piece of hardware, or in the cloud.

The method described herein may allow for superior performance on desired tasks and has the flexibility to automatically adapt to different requirements (for example optimizing for FLOPS or memory usage). There is no need for a human expert when forming the student model.

The method has a much higher sample efficiency than prior methods. For example, in some implementations, 20× less samples are needed than in prior techniques. The method is capable of performing true multi-objective optimization (instead of a simple weighted sum). The method also has the capability of dealing with large capacity gaps through the use of teaching assistants.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A machine learning mechanism implemented by one or more computers (506), the mechanism having access to a base neural network (104, 301, 302) and being configured to determine a simplified neural network (105, 303) by iteratively performing the following set of steps:
forming (201) sample data by sampling the architecture of a current candidate neural network;
selecting (202), in dependence on the sample data, an architecture for a second candidate neural network;
forming (203) a trained candidate neural network by training the second candidate neural network, wherein the training of the second candidate neural network comprises applying feedback to the second candidate neural network in dependence on a comparison of the behaviours of the second candidate neural network and the base neural network (104, 301, 302); and
adopting (204) the trained candidate neural network as the current candidate neural network for a subsequent iteration of the set of steps.

2. A machine learning mechanism as claimed in claim 1, comprising, after multiple iterations of the said set of steps, outputting the current candidate neural network as the simplified neural network (105, 303).

3. A machine learning mechanism as claimed in claim 1, wherein the simplified neural network (105, 303) has a smaller capacity and/or is less computationally intensive to implement than the base neural network (104, 301, 302).

4. A machine learning mechanism as claimed in claim 1, wherein the step of selecting an architecture for the second candidate neural network is performed by Bayesian optimisation.

5. A machine learning mechanism as claimed in claim 4, wherein the step of selecting an architecture for the second candidate neural network is performed by multi-objective Bayesian optimisation.

6. A machine learning mechanism as claimed in claim 4, wherein the step of selecting an architecture for the second candidate neural network is performed by Bayesian optimisation having one or more objectives, wherein at least one of said objectives refers to one or more of (i) improved classification accuracy of the second candidate neural network and (ii) reduced computational intensiveness of the second candidate neural network.

7. A machine learning mechanism as claimed in claim 1, wherein the sample data is formed by sampling the current candidate neural network according to a predetermined acquisition function.

8. A machine learning mechanism as claimed in claim 1, wherein the step of selecting an architecture for a second candidate neural network is performed by optimisation over a stochastic graph of network architectures (102).

9. A machine learning mechanism as claimed in claim 1, wherein the step of forming the trained candidate neural network comprises causing the second candidate neural network to perform a plurality of tasks, causing the base neural network to perform the plurality of tasks, and modifying the second candidate neural network in dependence on a variance between the performances of the second candidate neural network and the base neural network in performing the tasks.

10. A machine learning mechanism as claimed in claim 1, wherein the mechanism has access to a trained neural network (301) and is configured to determine the base neural network (302) by iteratively performing the following set of steps:
forming (404) sample data by sampling the architecture of a current candidate base neural network;
selecting (402), in dependence on the sample data, an architecture for a second candidate base neural network;
forming (403) a trained candidate base neural network by training the second candidate base neural network, wherein the training of the second candidate base neural network comprises applying feedback to the second candidate base neural network in dependence on a comparison of the behaviours of the second candidate base neural network and the trained neural network (301); and
adopting (404) the trained candidate base neural network as the current candidate base neural network for a subsequent iteration of the set of steps; and
after multiple iterations of those steps, adopting (405) the current candidate base neural network as the base neural network (302).

11. A machine learning mechanism as claimed in claim 10, wherein the base neural network (302) has a smaller capacity and/or is less computationally intensive to implement than the trained neural network (301).

12. A machine learning mechanism as claimed in claim 10, wherein the base neural network (302) is a teaching assistant network for facilitating the formation of the simplified neural network (303).

13. A machine learning mechanism as claimed in claim 1, the mechanism being configured to install the simplified neural network (105, 303) for execution on a device (501) having lower computational complexity than the said one or more computers (506).

14. A machine learning mechanism as claimed in claim 13, wherein the step of selecting an architecture for a second candidate neural network is performed by optimisation over a stochastic graph of network architectures (102), the stochastic graph having been predetermined in dependence on one or more capabilities of the said device (501).

15. A computer-implemented method for determining a simplified neural network (105, 303) in dependence on a base neural network (104, 301, 302), the method comprising iteratively performing the following set of steps:
forming (201) sample data by sampling the architecture of a current candidate neural network;
selecting (202), in dependence on the sample data, an architecture for a second candidate neural network;
forming (203) a trained candidate neural network by training the second candidate neural network, wherein the training of the second candidate neural network comprises applying feedback to the second candidate neural network in dependence on a comparison of the behaviours of the second candidate neural network and the base neural network (104, 301, 302); and
adopting (204) the trained candidate neural network as the current candidate neural network for a subsequent iteration of the set of steps.

16. A computer-implemented method as claimed in claim 15, comprising, after multiple iterations of the said set of steps, outputting the current candidate neural network as the simplified neural network (105, 303).

17. A computer-implemented method as claimed in claim 15, wherein the simplified neural network (105, 303) has a smaller capacity and/or is less computationally intensive to implement than the base neural network (104, 301, 302).

18. A computer-implemented method as claimed in claim 15, wherein the step of selecting an architecture for the second candidate neural network is performed by Bayesian optimisation.

19. A computer-implemented method as claimed in claim 18, wherein the step of selecting an architecture for the second candidate neural network is performed by multi-objective Bayesian optimisation.

20. A computer-implemented method as claimed in claim 18, wherein the step of selecting an architecture for the second candidate neural network is performed by Bayesian optimisation having one or more objectives, wherein at least one of said objectives refers to one or more of (i) improved classification accuracy of the second candidate neural network and (ii) reduced computational intensiveness of the second candidate neural network.
